(19) United States
(12) Patent Application Publication
(10) Pub. No.: US 2011/0010289 A1
(43) Pub. Date: Jan. 13, 2011

(54) Method And System For Controlling Risk Using Static Payment Data And An Intelligent Payment Device

(75) Inventor: Arthur D. Kranzley, Pound Ridge, NY (US)

Correspondence Address: BAKER BOTTS L.L.P., 30 ROCKEFELLER PLAZA, 44TH FLOOR, NEW YORK, NY, 10112-4498, US

(73) Assignee: Mastercard International Incorporated, Purchase, NY (US)

(21) Appl. No.: 12/598,717

(22) PCT Filed: May 1, 2008
(86) PCT No.: PCT/US08/62200

§ 371 Date: Sep. 9, 2010

Related U.S. Application Data
(60) Provisional application No. 60/915,858, filed on May 3, 2007.

(51) Int. Cl. G06Q 20/00; G06F 17/30

(52) U.S. Cl. 705/39; 235/380; 707/769; 707/E17.014

(57) ABSTRACT

Example embodiments are described that permit a merchant to conduct a payment transaction using a customer's intelligent payment device when it is determined that the customer has an intelligent payment device. In the absence of such a device, the merchant may conduct the payment transaction using a traditional payment token, for example a payment token including static data. The static data may include an intelligent device data, for example a code embedded on a magnetic stripe, that may alert a merchant to the existence of the intelligent payment device. The merchant may then conduct the payment transaction using the intelligent payment device instead of using the static data.

### RELATED APPLICATION

This application claims priority to U.S. provisional patent application 60/915,858, entitled Method and System for Controlling Risk Using Static Payment Data and an Intelligent Payment Device, filed May 3, 2007, which is incorporated by reference herein.

### BACKGROUND

Trying to insure the security of payment transactions has been a great concern of purchasers, vendors, and financial institutions alike. Purchasers fear identity theft and unauthorized use of their payment accounts. Financial institutions often shoulder the cost of fraudulent transactions, hoping to maintain customer loyalty. Vendors are under pressure by financial institutions to improve their systems' defenses against unauthorized transactions.

Traditional payment tokens, for example payment cards, often store static information, for example, on magnetic stripes, on the payment token itself. This static data may include information useful in conducting a payment transaction, for example, some or all of the following data: the token holder's name and payment account number; the payment token's expiration date and service code; and other discretionary data specific to the payment token issuer. This discretionary data may include a security code, known or derivable only by the issuer of the payment token. At the time of a transaction, a point of interaction (POI) terminal may read some or all of the data stored on the magnetic stripe. The extracted data may then be used to generate a transaction message, such as an authorization request message, containing additional data such as the amount of the transaction, merchant identification information, date, time, and other information. This transaction message may be sent to a data processing center associated with the institution that issued the payment token, where a decision is made as to whether to authorize the transaction based on data included in the transaction message. Where a security code is provided in the discretionary or magnetic stripe transaction data, the card issuer can verify that the security code is the correct code associated with the payment account number, through various techniques known to persons of skill in the art. Such payment tokens, however, may be susceptible to copying and may be used by criminals to perpetrate fraudulent transactions.

Newer payment tokens contain intelligence that permit the generation of dynamic data at the time of the transaction. Owing to their ability to generate dynamic data, these payment tokens are more difficult for fraudsters to copy and may be more secure for all parties. Examples of such devices include smart cards with contact pads for permitting direct electrical contact between the payment card and a POI terminal, and contactless payment cards or devices, perhaps including an antenna for communicating contactlessly with a POI terminal.

While many merchants in the United States have invested in POI terminals capable of reading payment tokens that include static data, such as magnetic stripes, few have added the ability to conduct transactions using the newer payment tokens. However, newer payment tokens are beginning to be rolled out to payment token holders, and merchants have begun to invest in updated terminals that are capable of interacting with these new payment tokens.

Some payment tokens that have been provided to payment token holders include both static data, as described above, as well as an intelligent payment device capable of generating dynamic data. Some payment token holders receive separate payment tokens, one including static information and another, associated token including an intelligent payment device. In both of these cases, the cardholder has an intelligent payment device and a static data device, either of which can be used in certain circumstances to perform a transaction. At many merchants or other POI terminals, the payment token holder may be able to choose whether to perform a transaction using the static data or the intelligent payment device. Payment token issuers may prefer that the token holder utilize the intelligent payment device whenever a POI device exists that can interact with the intelligent payment device. This permits the use of dynamic authentication at the time of transaction and may provide greater security and lower the risk of fraud associated with the transaction.

### SUMMARY

Methods and Systems for Controlling Risk Using Static Payment Data and an Intelligent Payment Device are described herein.

One example embodiment may include a procedure for conducting a payment transaction between a merchant and a holder of a payment token comprising receiving magnetic stripe data from a magnetic stripe on said payment token; determining the existence of an intelligent payment device associated with said payment token based at least in part on said magnetic stripe data; determining the existence of an intelligent point of interaction device accessible to said merchant, said intelligent point of interaction device being capable of conducting a contactless payment transaction with said intelligent payment device; and requiring said merchant to conduct said payment transaction using said intelligent payment device and said intelligent point of interaction device based at least in part on the result of said determining the existence of said intelligent payment device.

One example embodiment may include a procedure wherein said magnetic stripe data includes an intelligent device data, said intelligent device data indicating whether said intelligent payment device exists. One example embodiment may include a procedure wherein said intelligent device data is a code. One example embodiment may include a procedure wherein said merchant determines, from said intelligent device data, whether said intelligent payment device exists. One example embodiment may include a procedure wherein a data processing center, distinct from said merchant, determines, from said intelligent device data, whether said intelligent payment device exists. One example embodiment may include a procedure wherein said data processing center is the issuer of said payment token. One example embodiment may include a procedure wherein said magnetic stripe data includes static data. One example embodiment may include a procedure wherein said static data includes an intelligent device data. One example embodiment may include a procedure wherein said intelligent payment device includes a data processor. One example embodiment may include a procedure wherein said intelligent payment device includes a contactless interface. One example embodiment may include a procedure wherein said intelligent payment device includes contacts configured to interface with said intelligent point of interaction device. One example embodiment may include a procedure further comprising receiving the results of performing a risk analysis, wherein said requiring step is further based on the result of said risk analysis. One example embodiment may include a procedure wherein said risk analysis is based at least in part on whether a currency amount associated with said payment transaction exceeds a predetermined amount. One example embodiment may include a procedure wherein said risk analysis is based at least in part on past transaction activity associated with said payment token. One example embodiment may include a procedure further comprising conducting said payment transaction using said intelligent payment device and said intelligent point of interaction device when an intelligent device data indicates that said intelligent payment device exists. One example embodiment may include a procedure further comprising conducting said payment transaction using said intelligent payment device and said intelligent point of interaction device when said intelligent point of interaction device is determined to exist. One example embodiment may include a procedure further comprising retrieving a payment token identifier from said magnetic stripe data; receiving the results of querying a database using said payment token identifier; and determining the existence of said intelligent payment device based at least in part on the results of the database query. One example embodiment may include a procedure further comprising retrieving a payment account identifier from said magnetic stripe data; receiving the results of querying a database using said payment account identifier; and determining the existence of said intelligent payment device based at least in part on the results of the database query.

One example embodiment may include example components for conducting a payment transaction between a merchant and a payment token holder comprising a receiving component capable of receiving magnetic stripe data from a magnetic stripe on a payment token; a determination component configured to determine the existence of an intelligent payment device associated with said payment token based at least in part on said magnetic stripe data; and a requirement component capable of requiring said merchant to conduct said payment transaction using said intelligent payment device and an intelligent point of interaction device based at least in part on the result of determining the existence of said intelligent payment device, wherein said intelligent point of interaction device is accessible to said merchant, said intelligent point of interaction device capable of conducting a contactless payment transaction using said intelligent payment device.

One example embodiment may include example components wherein said magnetic stripe data includes an intelligent device data, said intelligent device data indicating whether said intelligent payment device exists. One example embodiment may include example components wherein said intelligent device data is a code. One example embodiment may include example components wherein said merchant determines, from said intelligent device data, whether said intelligent payment device exists. One example embodiment may include example components wherein a data processing center, distinct from said merchant, determines, from said intelligent device data, whether said intelligent payment device exists. One example embodiment may include example components wherein said data processing center is the issuer of said payment token. One example embodiment may include example components wherein said payment token data includes static data. One example embodiment may include example components wherein said static data includes an intelligent device data. One example embodiment may include example components wherein said intelligent payment device includes a data processor. One example embodiment may include example components wherein said intelligent payment device includes a contactless interface. One example embodiment may include example components wherein said intelligent payment device includes contacts configured to interface with said intelligent point of interaction device. One example embodiment may include example components wherein said merchant being required to conduct said payment transaction using said intelligent payment device and said intelligent point of interaction device is further based on a risk analysis. One example embodiment may include example components wherein said risk analysis is based at least in part on whether a currency amount associated with said payment transaction exceeds a predetermined amount. One example embodiment may include example components wherein said risk analysis is based at least in part on past transaction activity associated with said payment token. One example embodiment may include example components wherein said payment transaction is conducted by said intelligent point of interaction device when an intelligent device data indicates that said intelligent payment device exists. One example embodiment may include example components wherein said payment transaction is conducted by said intelligent point of interaction device when said intelligent point of interaction device is determined to exist. One example embodiment may include example components further comprising a second receiving component capable of receiving a payment token identifier, said payment token identifier disposed within said magnetic stripe data; and a query component configured to query a database using said payment token identifier, said database including payment token identifiers and associated intelligent device data, wherein determining the existence of said intelligent payment device is based at least in part on the results of the query. One example embodiment may include example components further comprising a second receiving component capable of receiving a payment account identifier, said payment account identifier disposed within said magnetic stripe data; and a query component configured to query said database using said payment account identifier, said database including payment account identifiers and associated intelligent device data, wherein determining the existence of said intelligent payment device is based at least in part on the results of the query.

### BRIEF DESCRIPTION OF THE DRAWINGS

For a more complete understanding of example embodiments of the presently described subject matter and its advantages, reference is now made to the following description, taken in conjunction with the accompanying drawings, in which:

FIG. 1 is a flowchart of a procedure according to an example embodiment of the presently described subject matter.

FIG. 2 is a flowchart of a procedure according to another example embodiment of the presently described subject matter.

FIG. 3 is a flowchart of a procedure according to yet another example embodiment of the presently described subject matter.

FIG. 4 is a block diagram of components according to an example embodiment of the present presently described subject matter.

FIG. 5 is a block diagram of data according to an example embodiment of the presently described subject matter.

FIG. 6 is a block diagram of data according to yet another embodiment of the presently described subject matter.

### DETAILED DESCRIPTION

Generally, example embodiments are described that permit a merchant to conduct a payment transaction using a customer's intelligent payment device when it is determined that the customer has an intelligent payment device. In the absence of such a device, the merchant may conduct the payment transaction using a traditional payment token, for example a payment token including static data. The static data may include an intelligent device data, for example a code embedded on a magnetic stripe, that may alert a merchant to the existence of the intelligent payment device. The merchant may then conduct the payment transaction using the intelligent payment device instead of using the static data.

In this way, merchants may continue to conduct transactions using traditional static data devices but may leverage the additional security offered by intelligent payment devices when such devices are present. As a result, customers, merchants, and financial institutions may be further protected from fraud. In addition, merchants may take advantage of these additional security measures without requiring all customers to possess intelligent payment devices.

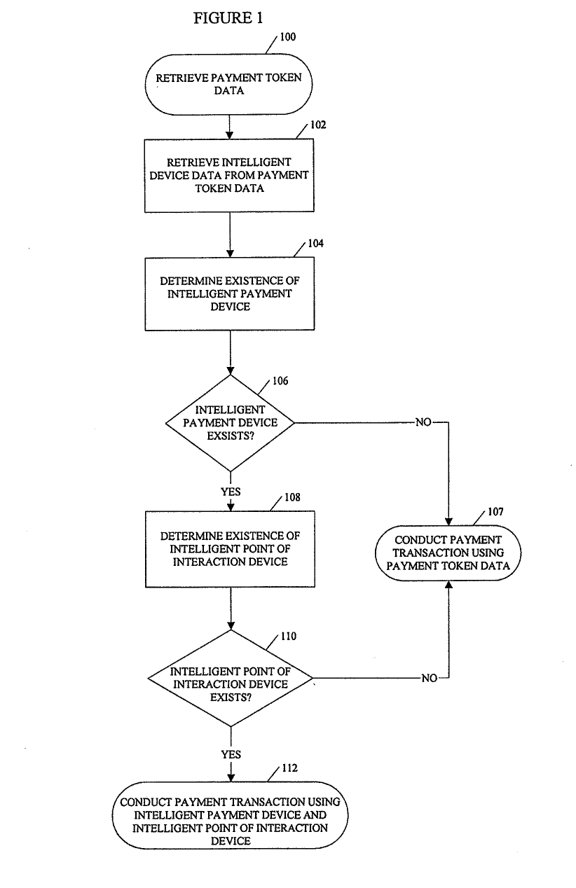

FIG. 1 depicts an example procedure according to an example embodiment of the presently described subject matter. A customer may possess a payment token issued by a payment token issuer. The payment token may include any physical or non-physical device capable of being used to conduct a transaction. A physical device may include devices that the customer may carry with himself and present at the point of sale. For example, physical payment tokens may include payment cards such as credit cards, debit cards, stored value cards, etc. Other physical payment tokens may include key fobs with static data included thereon. Non-physical payment tokens may include data presented to a merchant at the point of sale, which the merchant may use to conduct the transaction. For example, non-physical payment tokens may include an identifier presented to the merchant at the point of sale. The merchant may enter the identifier into a terminal with access to customer account data and thus identify the customer account from which to process the payment transaction. For added security, the merchant may present the customer with a challenge question to which only the customer knows the answer. When the customer provides the correct response, the payment transaction may be processed. In another example embodiment, the customer may provide a fingerprint or other biometric data (such as a retinal scan), and the transaction may be conducted by the merchant's looking up the information that corresponds to this data.

A payment token issuer may include a financial institution at which the customer has an account and from which funds may be cleared during the payment transaction. For example, banks and other financial institutions may permit a customer to open an account. Customer accounts may include credit, debit, and other types of accounts. The account may be associated with a payment token that when presented to a merchant at a point of sale permits the merchant to receive payment from the financial institution.

A merchant may include an entity from which the customer wishes to obtain goods, services, etc. The merchant may charge the customer for those goods or services. For example, a merchant may include a store, on-line vendor, etc.

The payment token may include payment token data. The payment token may be retrieved (block 100), for example, by a merchant. The payment token data may be associated with the payment token, for example, by being encoded on the payment token itself. It is contemplated that any association between payment token and payment token data may exist. For example, the payment token data may include data encoded on a magnetic stripe located on the payment token itself. In another example embodiment, other methods of encoding data may exist, such as by ink or other physical marking, RFID technology, infrared technology, etc.

The payment token data may include various types of information. In one example embodiment, the data may include information that identifies the customer account with which the payment token is associated (e.g., an account number, identifying information of the payment token issuer, etc.). In another example embodiment, the data may include information that identifies the customer (e.g., customer name, address, account number, fingerprint identifying information, etc.). One example embodiment may include magnetic stripe data in the track 1 format, such as that which appears on various payment cards.

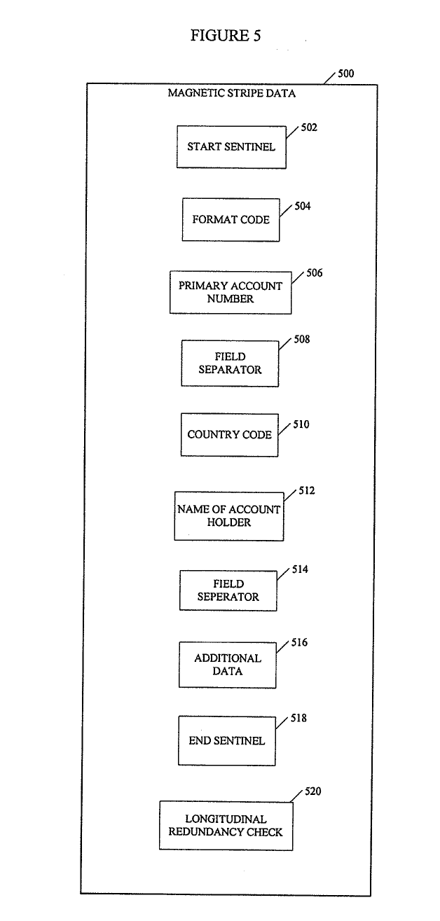

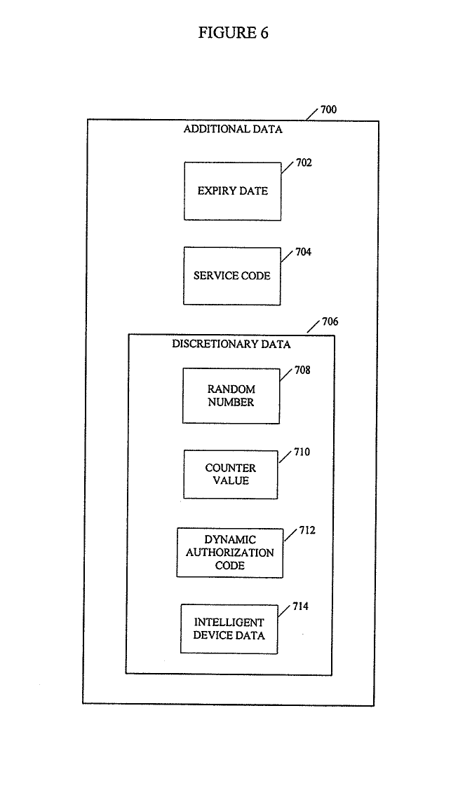

FIG. 5 depicts example data according to an example embodiment of the presently described subject matter. Magnetic stripe data 500 may include a start sentinel 502, format code 504, primary account number 506, field separator 508, country code 510, name of card holder 512, field separator 514, additional data 516, end sentinel 518, and redundancy check 520. Additional data 516 may include various fields, for example those shown in FIG. 6.

FIG. 6 depicts example data according to another example embodiment of the presently described subject matter. Additional data 600 may include expiry date 602, service code 604, and discretionary data 606. Discretionary data 606 may further include a random number 608, counter value 610, dynamic authorization code 612, and an intelligent device 614.

Returning to FIG. 1, the payment token data may exist statically. Static data may include data which remains constant when not acted upon by an outside entity. For example, static data may include data encoded on a magnetic stripe on a payment token. In one example embodiment, the static data may not be changed and may be permanent. This type of data may be most susceptible to being copied and used in fraudulent transactions because a fraudster may copy the data once, generate a new payment token with the copied data, and use the fraudulent payment token to conduct payment transactions.

In another example embodiment, even though the data remains static, it may change if acted upon by an outside entity. For example, information encoded on the payment token may be updated periodically by an outside entity, such as a merchant. For example, a merchant may, at the behest of the payment token issuer, change data on the payment token by erasing the existing data and replacing it with new data. For example, a customer may be asked to swipe their card through a POI device twice—once to read the data and once to write the updated data. The updated data may include information such as a transaction counter. If a fraudster used a copied card, either the transaction counter reported to the payment token issuer would not correspond with the current count (such as if the customer has made a transaction between the time the card was copied and when the copied card was used) or the customer may detect that a fraudulent transaction has taken place because the counter would not match what the current value should be.

The merchant may retrieve an intelligent device data from the payment token data (block 102). The merchant may use the intelligent device data to determine whether an intelligent payment device exists (block 104).

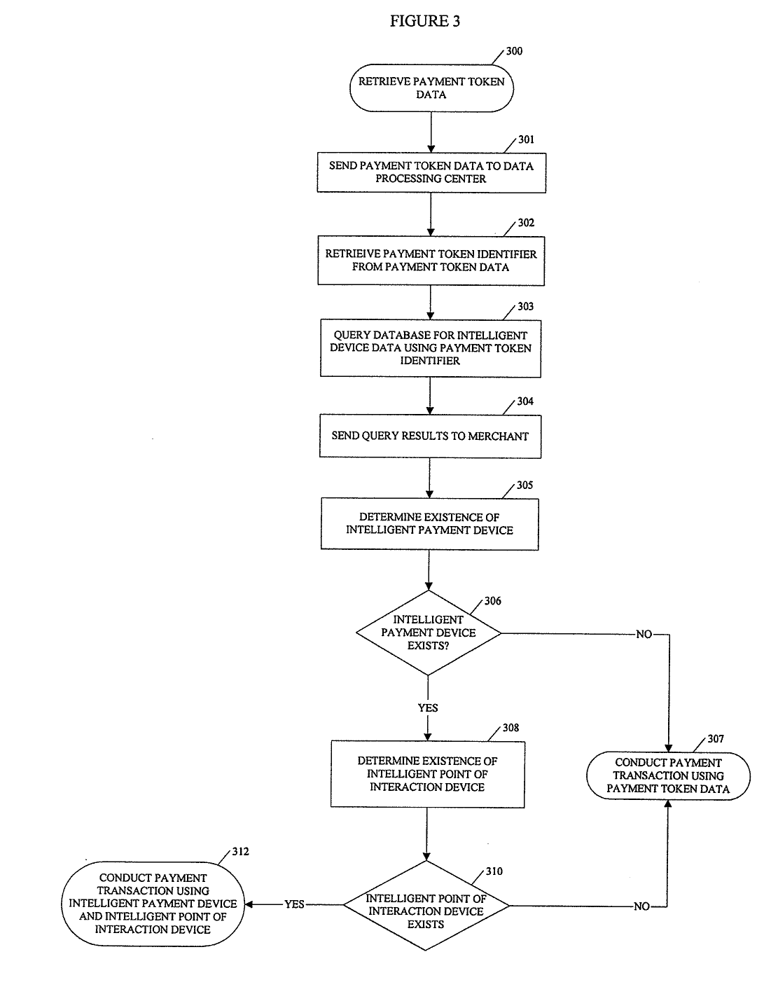

The intelligent device data may be derivable from the payment token data. In one example embodiment, the intelligent device data may be included in the payment token data, such as by being encoded alongside the payment token data. One such example of this encoding is depicted in FIG. 6. Intelligent device data 614 may be encoded in the additional data 600 of the track 1 data located on various payment cards. In another example embodiment, the intelligent device data may be derivable based on the payment token data (as shown in FIG. 3). In yet another example embodiment, the intelligent device data may be encoded in the payment token data (such as in the customer's name, address, etc.).

The form of the intelligent device data may vary according to the requirements of the payment token system. For example, the intelligent device data may exist as a code. The code may indicate, perhaps with a 1 or a 0, whether an intelligent payment device associated with the payment token exists. In another example, a “y” or “n” may indicate whether the intelligent payment device exists. It is contemplated that other encodings of the intelligent device data may exist, including other alphanumeric identifiers, executable code, encrypted data, references to other locations from which the data may be retrieved, or electronic circuitry which may query to see if an intelligent payment device exists. In one example embodiment, the intelligent device data may exist in a different medium than the remainder of the payment token data, such as existing as an RFID on a payment token where the remainder of the payment token data is encoded on a magnetic stripe.

The intelligent payment device may include various components and take various forms according to the requirements of the payment token system. In one example embodiment, the intelligent payment device may produce dynamic data that may be used to protect against fraudulent transactions. The merchant, payment token issuer, or other party may be able to determine, from the dynamic data, that the intelligent payment device is indeed authentic. For example, the dynamic data may include data from a challenge response algorithm. A payment token issuer may issue a challenge, by way of the POI device at the merchant site, to the intelligent payment device on the payment token. The intelligent payment device may include logic to produce a response to the challenge. The response may be sent back to the payment token issuer. The payment token issuer may determine, based on the response, whether the intelligent payment device is legitimate. The intelligent payment device and the payment token issuer may have been previously configured to correctly issue and respond to such challenge messages. In one example embodiment, the intelligent payment device itself may be capable of issuing challenges to the payment token issuer to determine whether the payment token issuer itself is authentic. In another example embodiment, the intelligent payment device may execute encryption algorithms designed to protect the data in transit from the intelligent payment device to the payment token issuer. For example, symmetric key or public/private key algorithms may be employed. The payment token issuer may additionally authenticate the intelligent payment device based on whether the intelligent payment device correctly executes the encryption algorithm. In one example embodiment, the intelligent payment device may transmit a digital signature for authentication.

In another example embodiment, the intelligent payment device may be authenticated based on a regularly changing code. The intelligent payment device may produce a code based on a regularly running algorithm. The payment token issuer and the intelligent payment device may be synchronized such that the same code is produced by both entities. Only the correct intelligent payment device may be capable of producing the correct code, and therefore the intelligent payment device may be authenticated. In practice, many other algorithms using dynamic data are contemplated to secure payment transactions using the intelligent payment device.

The intelligent payment device may include an interface to communicate with appropriate intelligent POI devices. In one example embodiment, the interface may be a contactless interface. Contactless interfaces may include interfaces that permit data to be wirelessly transferred to an intelligent POI device, from the intelligent POI device, pr between the payment token and the intelligent POI device. Example forms of contactless communication may include radio frequency, infrared, wireless local area networks, wireless wide area networks, satellite, BlueTooth, near field communication (NFC), etc. The intelligent payment device may include a device for sending and receiving signals and circuitry for interpreting, processing, and responding to the communications. For example, the intelligent payment device may include one or more processors and/or one or more antennas. One example of such an intelligent payment token may include wireless smart cards.

In one example embodiment, the intelligent payment device may be included on the same physical device as the payment token. For example, a payment card may include a magnetic stripe as well as an embedded processor and radio frequency communications circuitry. In another example embodiment, the payment token may include a smart card with a traditional magnetic stripe for conducting traditional payment transactions. In another example, the intelligent payment device may be a separate device, such as a key fob located on the customer's key chain. Other separate devices may include a separate card, a device embedded in the customer's body, a mobile phone, PDA or other mobile device, a separate flash memory device, or any other separate memory unit.

Communications between the intelligent POI device and the intelligent payment device may also include contact interfaces. Contact interfaces may include interfaces in which a portion of the intelligent payment device is in physical contact with a portion of the intelligent POI device. Communications may be established over the contact interface, such as by using wired communication protocols well known to those skilled in the art. Examples may include RS232 communications, USB communications, etc. In one example embodiment, the interface may include communication with electrical leads directly on a processor, which may be included in the intelligent payment device.

If the intelligent payment device does not exist (block 106), then the merchant may conduct the payment transaction using the payment token data (block 107). For example, the merchant may retrieve the necessary information from the payment token data, such as the payment token identifier, customer account identifier, customer name and address, and any security information. The merchant may form a transaction message and may send the message to a data processing center associated with a financial institution or the payment token issuer. The data processing center may indicate whether the payment transaction was successful by verifying the data sent in the transaction message.

If the intelligent payment device does exist (block 106), then the merchant may attempt to determine whether an appropriate intelligent POI device exists (block 108). The merchant may attempt to communicate with an appropriate intelligent POI device. If no such intelligent POI device communication can be established, the intelligent POI device may be determined not to be accessible to the merchant or exist. In another example embodiment, the merchant may consult a data store to determine whether an appropriate intelligent POI device exists. The merchant may determine the requirements for an appropriate intelligent POI device from the intelligent device data and perform a search to determine whether the merchant site includes the appropriate intelligent POI device. In yet another example embodiment, the software at the merchant site may automatically route communications to the intelligent POI device when one exists and automatically route communications to a conventional POI device when no intelligent POI device exists.

In one example embodiment, one aspect of identifying an appropriate intelligent POI device may be determining the particular type of interface used by the intelligent payment device. For example, in order to communicate with a contactless intelligent payment device using infrared, an intelligent POI device capable of communicating using infrared may be required. For example, information embedded in the intelligent device data may include the parameters used to identify an appropriate intelligent payment device such as the communications medium or communications protocols of the intelligent payment device, makes and models of compatible intelligent POI devices, or the like. In one example embodiment, the merchant may read the intelligent device data and may determine whether the merchant site includes the appropriate intelligent POI device. In another example embodiment, the intelligent payment device itself may determine the existence of an appropriate intelligent POI device, for example, by sending out a detection message and reporting the results to the merchant or thereby conducting the transaction using the intelligent payment device. For example, the payment token may include an embedded, contactless intelligent payment device. Once the merchant initiates gathering information from the payment token data (e.g. by reading a magnetic stripe), the embedded, contactless intelligent payment device may send out a message over the contactless interface. The embedded, contactless intelligent payment device may await an appropriate response from an appropriate intelligent POI device. If one is found, the intelligent payment device may automatically begin the payment transaction over the contactless interface. If no such appropriate response is forthcoming, the query may time out and the payment transaction may continue in the traditional manner. In yet another example embodiment, information regarding the intelligent payment device and the merchant's POI devices may be compared by a third party organization that may alert the merchant if a match between the intelligent payment device and an intelligent POI device exists.

If no intelligent POI device capable of communicating with the intelligent payment device using the intelligent payment device's interface exists (block 110), then the intelligent POI device may be determined not to be accessible or exist and the payment transaction may be conducted using the payment token data (block 107). If, however, an appropriate intelligent POI device does exist and is accessible to the merchant (block 110), then the payment transaction may be carried out using the intelligent payment device and the intelligent POI device over the appropriate interface (block 112). In one example embodiment, the customer may be presented with the option to perform the payment transaction using the intelligent payment device. In another example embodiment, the merchant may be required to perform the payment transaction using the intelligent payment device when an appropriate intelligent POI device is determined to exist.

The specific order of determining the existence of an intelligent payment device and an intelligent POI device is immaterial to the description herein. In yet another example embodiment, it may first be determined what, if any, intelligent POI devices a merchant possesses. Then, it may be determined whether the customer possesses an appropriate intelligent payment device to communicate with the merchant's intelligent POI device. For example, the intelligent POI device may send out a detection message, and if an appropriate intelligent payment device exists, receive a response message from the intelligent payment device. The payment transaction may thus be commenced using the intelligent payment device.

The intelligent POI device may be accessible by the merchant if it is either immediately accessible or intermittently accessible. For example, an intelligent POI device may be immediately accessible where the merchant need not wait for other circumstances to communicate with the intelligent POI device. Direct connections, such as hard wired or direct wireless connections may provide immediate accessibility. In another example embodiment, intermittent accessibility may include waiting for a particular condition or conditions to be satisfied before the intelligent POI device may be accessed. For example, a protocol may specify that a communications channel between a POI device and a merchant may be established every several minutes, such as in a situation where power must be conserved. Alternatively, a handshake protocol may be necessary to begin transmissions to and from an intelligent POI device. Unless the handshake protocol or other connection initiation conditions are fulfilled, the merchant may be unable to access the intelligent POI device.

In one example embodiment, a decision as to whether or not to conduct the payment transaction using the intelligent payment device may also depend, at least in part, on a risk analysis. The merchant, the payment token issuer, or any appropriate third party may perform the risk analysis. A risk analysis may include making an observation and determining whether the observation satisfies a particular condition.

The condition to be satisfied may be related to any aspect in accordance with the requirements of the particular system. For example, a condition may be related to aspects of the customer (e.g., whether they appear on a transaction warning list or police report, whether the customer's past transaction history includes fraudulent transactions, whether the number of prior transactions is below a requisite number, whether other merchants have reviews to process transactions by the customer, etc.). In another example embodiment, conditions may be related to aspects of the merchant (e.g., whether the merchant is in a high crime area, previous fraudulent transactions from the merchant location, the length of time that the merchant has been in business, etc.). In yet another example embodiment, conditions may be related to aspects of the payment transaction itself (e.g., the type of goods involved, the amount of the transaction, whether the transaction is a face-to-face transaction or not, etc.). In a further example embodiment, conditions may be related to aspects other than those related to the customer, merchant, or the payment transaction (e.g., current laws in the jurisdiction where the transaction is taking place, rules of the payment token issuer, etc.).

In one example embodiment, the amount of the transaction may impact whether or not the intelligent payment device may be required. If the payment transaction amount exceeds a particular amount, such as a predetermined amount, then the transaction may pose a greater risk. The merchant may be required to use the intelligent payment device. A predetermined amount may include an amount which is set at any time before the payment transaction has been completed.

In another example embodiment, past transaction history may dictate, at least in part, whether the intelligent payment device may be required. For example, a merchant may be required to conduct transactions with the intelligent payment device if the merchant has been the target of an unusually high number of fraudulent transactions. The merchant may be deemed to pose a high risk. In another example embodiment, new merchants, for example those who have processed relatively few transactions, may also be deemed to pose a high risk because they may not have shown themselves trustworthy to screen their customers well.

Once it has been established that the condition is satisfied, the payment transaction may proceed using the intelligent payment device. Otherwise, if the condition is not satisfied, the payment transaction may be determined not to pose a threat, and the payment transaction may be completed using the payment token data. The risk analysis may be combined with whether or not the intelligent payment device exists to determine whether or not to proceed with the payment transaction using the intelligent payment device or the payment token data. A similar analysis of a customer's transaction history or the transaction history of the particular payment token may be considered in analyzing risk.

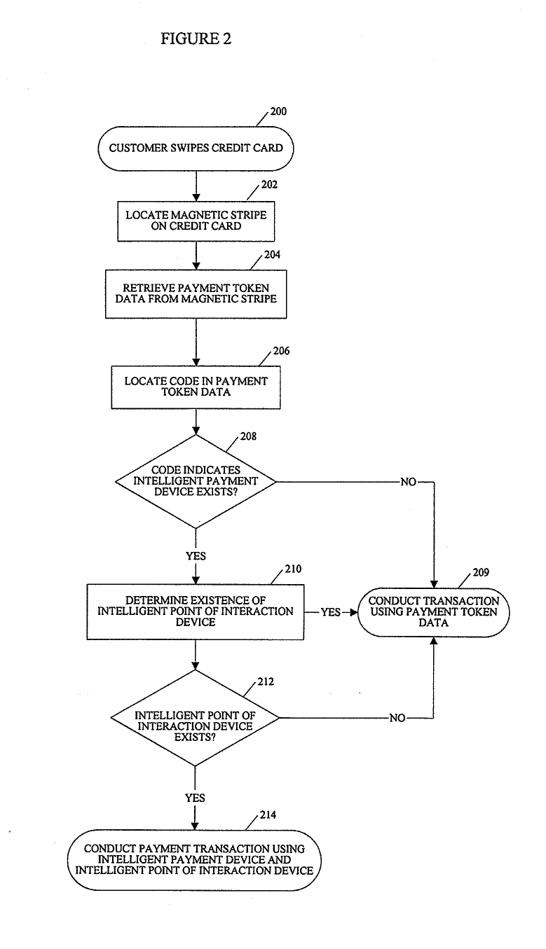

FIG. 2 depicts an example procedure according to another example embodiment of the presently described subject matter. A payment transaction may be carried out using a credit card or, if present, an intelligent payment device (such as an embedded processor on the credit card). A customer, possessing a credit card account with a credit card issuer, may swipe the credit card at a merchant site (block 200). The merchant site may include a credit card reader that may include a magnetic stripe reader. The merchant may locate the magnetic stripe (block 202) and retrieve the payment token data encoded on the magnetic stripe (block 204). The payment token data may include such data formats as that shown in FIGS. 5 and 6. The merchant may parse the payment token data and locate a code within the payment token data (block 206) that may indicate whether an associated intelligent payment device exists. If the code indicates that an associated intelligent payment device exists (block 208) and if an appropriate intelligent POI device exists (blocks 210 and 212), then the payment transaction may be conducted using the associated intelligent payment device and the intelligent POI device (block 214). Otherwise, the payment transaction may be conducted using the payment token data (block 209).

FIG. 3 depicts an example procedure according to yet another example embodiment of the presently described subject matter. Determination of whether an intelligent payment device exists may be performed by an entity other than the merchant. A customer wishing to purchase goods or services may present a traditional payment token (e.g., a credit card with a magnetic stripe). The merchant may retrieve the payment token data from the payment token (block 300) and send the payment token data to an outside entity (block 302), such as a data processing center. In one example embodiment, the data processing center may be the same entity as the issuer of the payment token. In another example embodiment, the data processing center may be associated with a third party, such as a company that manages and distributes intelligent POI devices.

The payment token data may include information identifying the customer (e.g., customer name and address, customer account number, customer ID, etc.), the payment token itself (e.g., a payment token identifier), and/or any other appropriate information from which to determine whether an intelligent payment device exists. The data processing center may receive the payment token data and retrieve the identifying information (e.g., the payment token identifier). The data processing center may perform a query for the associated intelligent device data (block 304), such as in a database, look-up table, flat file, or the like.

Once the results have been obtained, the merchant may determine whether an intelligent payment device exists. In one example embodiment, the data processing center may determine the existence of an intelligent payment device by examining the intelligent device data. The data processing center may then send the answer to the merchant. In another example embodiment, the data processing center may send the results of the query (e.g., the intelligent device data) to the merchant, and the merchant may examine the intelligent device data to determine whether the intelligent payment device exists (block 305).

If the intelligent payment device exists (block 306), then the merchant may determine whether an appropriate intelligent POI device exists (block 308). If an appropriate intelligent POI device exists (310), then the merchant may conduct the payment transaction using the intelligent payment device and intelligent POI device (block 312). If either the intelligent payment device does not exist or the intelligent POI device does not exist, then a traditional payment transaction may be conducted using the payment token data (block 307).

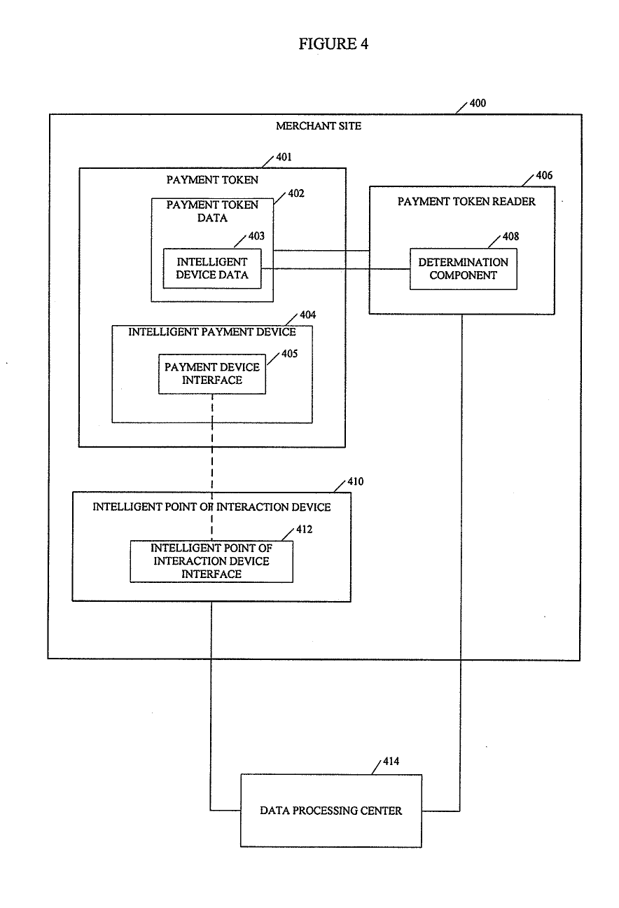

FIG. 4 depicts example components according to an example embodiment of the presently described subject matter. A customer may wish to conduct a payment transaction at a merchant site 400. The merchant may process the payment transaction through a data processing center 414. The merchant site may include a payment token reader 406, and an intelligent POI device 410. The customer may present a payment token 401 at the merchant site 400. The payment token 401 may include payment token data 402 and an intelligent payment device 404. The payment token data 402 may include an intelligent device data 403. The intelligent payment device 404 may include a payment device interface 405. The payment token reader 406 may retrieve the payment token data 402 from the payment token 401. A determination component 408 may retrieve the intelligent device data 403 from the payment token data 402. If the intelligent device data 403 indicates that the intelligent payment device 404 exists, then the merchant may determine whether an intelligent POI device 410 that is appropriate exists. If the intelligent POI device 410 exists, then communications may be established between the payment device interface 405 of the intelligent payment device 404 and the intelligent POI device interface 412 of the intelligent POI device 410. Data may be exchanged through the communications, and the payment transaction may be accomplished between the intelligent POI device 410 and the data processing center 414. If either the intelligent payment device 404 or the intelligent POI device 410 is determined not to exist, then the payment transaction may be accomplished using the payment token data 401 by communicating between the payment token reader 406 and the data processing center 414.

In one example embodiment, a receiving component capable of receiving magnetic stripe data may be provided. In another example embodiment, a determination component configured to determine the existence of an intelligent payment device may be provided. In yet another example embodiment, a requirement component capable of requiring a merchant to conduct a payment transaction using an intelligent payment device and an intelligent point of interaction device may be provided. In a further example embodiment, a second receiving component capable of receiving a payment account identifier (e.g., a customer account number or the like), payment token identifier (e.g., a payment card number or the like), etc. may be provided. In yet a further example embodiment, a query component configured to query said database using one or more identifiers may be provided. In various example embodiments, the foregoing components may each include hardware, software, or combinations thereof (e.g., such as one or more processors capable of executing instructions to accomplish the various operations necessary to carry out the tasks). The receiving, determination, and requirement components may include single or multiple processors, exist at a single location, be distributed over an appropriate communications medium, or otherwise be implemented in accordance with practices of one ordinarily skilled in the art.

Requiring the merchant or customer to conduct a payment transaction using the intelligent payment device may include any operations which prevent the merchant or customer from proceeding forward with the transaction without the intelligent payment device. For example, the payment token issuer may receive the results of a risk analysis and where the risk level is higher than a threshold, the payment token issuer may refuse to proceed with the payment transaction if an intelligent payment device is not used. In another example embodiment, the merchant may receive a message from the payment token issuer, or any other entity, that indicates the type of payment to use. In yet another example embodiment, an instruction may be issued to the merchant to direct which type of payment to use.

The foregoing merely illustrates the principles of the presently described subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the described subject matter and are thus within the spirit and scope of the described subject matter.

1. A method of conducting a payment transaction between a merchant and a holder of a payment token, comprising:
receiving magnetic stripe data from a magnetic stripe on said payment token;
determining the existence of an intelligent payment device associated with said payment token based at least in part on said magnetic stripe data;
determining the existence of an intelligent point of interaction device accessible to said merchant, said intelligent point of interaction device being capable of conducting a contactless payment transaction with said intelligent payment device; and
requiring said merchant to conduct said payment transaction using said intelligent payment device and said intelligent point of interaction device based at least in part on the result of said determining the existence of said intelligent payment device.

2. The method of claim 1, wherein said magnetic stripe data includes an intelligent device data, said intelligent device data indicating whether said intelligent payment device exists.

3. The method of claim 2, wherein said intelligent device data is a code.

4. The method of claim 2, wherein said merchant determines, from said intelligent device data, whether said intelligent payment device exists.

5. The method of claim 2, wherein a data processing center, distinct from said merchant, determines, from said intelligent device data, whether said intelligent payment device exists.

6. The method of claim 5, wherein said data processing center is the issuer of said payment token.

7. The method of claim 1, wherein said magnetic stripe data includes static data.

8. The method of claim 7, wherein said static data includes an intelligent device data.

9. The method of claim 1, wherein said intelligent payment device includes a data processor.

10. The method of claim 1, wherein said intelligent payment device includes a contactless interface.

11. The method of claim 1, wherein said intelligent payment device includes contacts configured to interface with said intelligent point of interaction device.

12. The method of claim 1, further comprising:
receiving results related to performing a risk analysis,
wherein said requiring step is further based on the result of said risk analysis.

13. The method of claim 12, wherein said risk analysis is based at least in part on whether a currency amount associated with said payment transaction exceeds a predetermined amount.

14. The method of claim 12, wherein said risk analysis is based at least in part on past transaction activity associated with said payment token.

15. The method of claim 1, further comprising:
conducting said payment transaction using said intelligent payment device and said intelligent point of interaction device when an intelligent device data indicates that said intelligent payment device exists.

16. The method of claim 1, further comprising:
conducting said payment transaction using said intelligent payment device and said intelligent point of interaction device when said intelligent point of interaction device is determined to exist.

17. The method of claim 1, further comprising:
retrieving a payment token identifier from said magnetic stripe data;
receiving the results of querying a database using said payment token identifier; and
determining the existence of said intelligent payment device based at least in part on the results of the database query.

18. The method of claim 1, further comprising:
retrieving a payment account identifier from said magnetic stripe data;
receiving the results of querying a database using said payment account identifier; and
determining the existence of said intelligent payment device based at least in part on the results of the database query.

19. A method of conducting a payment transaction between a merchant and a holder of a payment token, comprising:
receiving results related to determining the existence of an intelligent payment device associated with said payment token, said determining the existence of said intelligent payment device based at least in part on magnetic stripe data of said payment token;
receiving results related to determining the existence of an intelligent point of interaction device accessible to said merchant, said intelligent point of interaction device being capable of conducting a contactless payment transaction with said intelligent payment device; and
requiring said holder of said payment token to conduct said payment transaction using said intelligent payment device and said intelligent point of interaction device based at least in part on the results of said determining the existence of said intelligent payment device.

20. A system for conducting a payment transaction between a merchant and a payment token holder, comprising:
a receiving component capable of receiving magnetic stripe data from a magnetic stripe on a payment token;
a determination component configured to determine the existence of an intelligent payment device associated with said payment token based at least in part on said magnetic stripe data; and
a requirement component capable of requiring said merchant to conduct said payment transaction using said intelligent payment device and an intelligent point of interaction device based at least in part on the result of determining the existence of said intelligent payment device,
wherein said intelligent point of interaction device is accessible to said merchant, said intelligent point of interaction device capable of conducting a contactless payment transaction using said intelligent payment device.

21. The system of claim 20, wherein said magnetic stripe data includes an intelligent device data, said intelligent device data indicating whether said intelligent payment device exists.

22. The system of claim 21, wherein said intelligent device data is a code.

23. The system of claim 21, wherein said merchant determines, from said intelligent device data, whether said intelligent payment device exists.

24. The system of claim 21, wherein a data processing center, distinct from said merchant, determines, from said intelligent device data, whether said intelligent payment device exists.

25. The system of claim 24, wherein said data processing center is the issuer of said payment token.

26. The system of claim 20, wherein said payment token data includes static data.

27. The system of claim 26, wherein said static data includes an intelligent device data.

28. The system of claim 20, wherein said intelligent payment device includes a data processor.

29. The system of claim 20, wherein said intelligent payment device includes a contactless interface.

30. The system of claim 20, wherein said intelligent payment device includes contacts configured to interface with said intelligent point of interaction device.

31. The system of claim 20, wherein said merchant being required to conduct said payment transaction using said intelligent payment device and said intelligent point of interaction device is further based on a risk analysis.

32. The system of claim 31, wherein said risk analysis is based at least in part on whether a currency amount associated with said payment transaction exceeds a predetermined amount.

33. The system of claim 31, wherein said risk analysis is based at least in part on past transaction activity associated with said payment token.

34. The system of claim 20, wherein said payment transaction is conducted by said intelligent point of interaction device when an intelligent device data indicates that said intelligent payment device exists.

35. The system of claim 20, wherein said payment transaction is conducted by said intelligent point of interaction device when said intelligent point of interaction device is determined to exist.

36. The system of claim 20, further comprising:
a second receiving component capable of receiving a payment token identifier, said payment token identifier disposed within said magnetic stripe data; and
a query component configured to query a database using said payment token identifier, said database including payment token identifiers and associated intelligent device data,
wherein determining the existence of said intelligent payment device is based at least in part on the results of the query.

37. The system of claim 20, further comprising:
a second receiving component capable of receiving a payment account identifier, said payment account identifier disposed within said magnetic stripe data; and
a query component configured to query said database using said payment account identifier, said database including payment account identifiers and associated intelligent device data,
wherein determining the existence of said intelligent payment device is based at least in part on the results of the query.
